(19) United States
(12) Patent Application Publication
(10) Pub. No.: US 2011/0061771 A1
(43) Pub. Date: Mar. 17, 2011

(54) PROCESS FOR HEAT-TREATING AND COATING A COMPONENT AND COMPONENT PRODUCED BY THE PROCESS

(75) Inventors: Roland Treitler, Muenchen (DE); Sebastien Nissle, Eching (DE)

(73) Assignee: GEORG FISCHER DIENSTLEISTUNGEN GMBH, Mettmann (DE)

(21) Appl. No.: 12/918,844

(22) PCT Filed: Feb. 26, 2009
(86) PCT No.: PCT/EP2009/001370

§ 371 Date: Oct. 18, 2010

(30) Foreign Application Priority Data
Feb. 28, 2008 (EP) 08102124.8

(51) Int. Cl. C25D 7/00; C25D 5/00; C22C 21/00; C21D 1/00; B32B 15/20

(52) U.S. Cl. 148/518; 148/537; 148/437

(57) ABSTRACT

A process for heat-treating and coating a component, comprising the following steps: solution-annealing of the component and subsequent coating of the component which is heated to a temperature which is so high that it is thereby possible to carry out both heat treatment in order to set the material properties of the solution-annealed component and also the coating. An AlSi10MgMn aluminum alloy is preferably used. The solution-annealing takes place at 400-500° C. over the course of 5-120 minutes, and the age-hardening and coating take place at 150-300° C. over the course of 30-60 minutes. The coating may be carried out as cathodic or anodic dip painting.

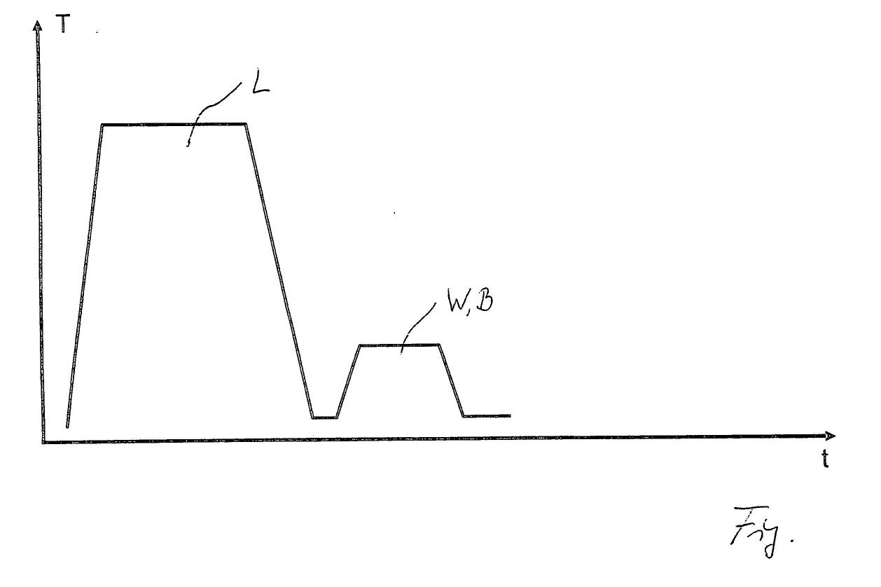

### BACKGROUND OF THE INVENTION

The invention relates to a process for heat-treating and coating a component.

It is known to solution-anneal a component, in particular a pressure die-cast component, after the pressure die-casting process. For this purpose, the component which has been cooled after the pressure die-casting is heated in a solution-annealing bath to a solution-annealing temperature for a specific time and then cools down again. In a later process step, the component is subjected to hot age-hardening. For this purpose, the component is brought to an increased temperature for a specific time, in order to set the material properties. The component then cools down again. In a later, final process step, the component is coated. For this purpose, it is heated to a coating temperature for a specific time. In particular, the coating takes place in the form of dip-coating. It is clear from the text above that the treatment of the component requires a large number of process steps with a corresponding input of energy.

The invention is therefore based on the object of specifying a process for heat-treating and coating a component, which process requires only few process steps and a relatively low input of energy.

### SUMMARY OF THE INVENTION

According to the invention, this object is achieved by virtue of the fact that the component is solution-annealed and then, for coating, the component is heated to such a high temperature that it is thereby possible to carry out—in particular simultaneously—both heat treatment in order to set the material properties of the solution-annealed component and also the coating. It is therefore possible to produce the component in a single process step, specifically heating the component to a temperature at which it is possible both to set the material properties and also to coat the component. The temperature according to the invention is higher than the conventional coating temperature known from the prior art, but lower than the solution-annealing temperature. It makes it possible to set the material properties in a manner which corresponds to the hot age-hardening known from the prior art, and nevertheless allows the coating to take place, i.e. although it is higher than the conventional temperature for coating, it nevertheless allows a proper, faultless coating process to be carried out.

As already explained, the temperature is preferably selected such that it is lower than the solution-annealing temperature and higher than the conventional coating temperature

The component used is, in particular, a pressure die-cast component. In particular, the component is produced from aluminum or an aluminum alloy, in particular an AlSi10MgMn alloy.

According to one development of the process according to the invention, it is provided that the solution annealing takes place at a temperature of 400° C. to 550° C., in particular at about 490° C. The solution annealing is preferably carried out over the course of 5 minutes to 120 minutes, in particular over the course of about 30 minutes.

The heat treatment and the coating preferably take place at a temperature of 150° C. to 300° C., in particular at about 220° C. The heat treatment and the coating are carried out over the course of 5 minutes to 240 minutes, in particular over the course of 30 minutes to 60 minutes, preferably over the course of about 45 minutes. Both the heat treatment and the coating take place within the stated time.

The coating is carried out, in particular, as cathodic dip-coating. The coating is accordingly a cathodic dip coating.

Finally, the invention relates to a component produced by the process explained above.

### BRIEF DESCRIPTION OF THE DRAWINGS

The figure explains the invention with reference to a graph.

### DETAILED DESCRIPTION

A component which has been produced as a pressure die-cast component, in particular made of AlSi10MgMn, in a pressure die-casting process is solution-annealed in a subsequent process step. In this respect, reference is made to the graph in the figure. The temperature T is shown on the ordinate and the time t is shown on the abscissa. For the solution annealing L, the component is heated to a temperature of 490° C. over the course of 30 minutes. The component then cools down again. In a subsequent process step, the component is both heat-treated W and coated B. For this purpose, the solution-annealed component is heated to a temperature of 220° C. over the course of 45 minutes. The material properties of the solution-annealed component are set by the heating and, during this heat treatment, the coating is carried out as cathodic or anionic dip-coating. The required mechanical properties are realized by the setting of the material properties, i.e. in particular the strength and the elongation at break are set.

The process of the invention is accordingly a two-stage heat treatment with integrated coating process. Considerable savings are made compared to the known process, which requires three furnace processes for solution annealing, hot age-hardening and for the coating process, and the properties demanded of the component are nevertheless completely satisfied.

1-10. (canceled)

11. A process for heat-treating and coating a component, comprising the steps of:
(a) solution-annealing of an aluminum component; and
(b) subsequently coating of the aluminum component which is heated to a temperature wherein both (1) heat treatment is carried out in order to set the material properties of the solution-annealed aluminum component and (2) the coating of the aluminum component.

12. The process as claimed in claim 11, including selecting the temperature wherein it is lower than the solution-annealing temperature and higher than a conventional coating temperature.

13. The process as claimed in claim 11, wherein the aluminum component is a pressure die-cast component.

14. The process as claimed in claim 11, wherein the aluminum component is produced from an AlSi10MgMn alloy.

15. The process as claimed in claim 11, wherein the solution annealing takes place at a temperature of 400° C. to 550° C.

16. The process as claimed in claim 15, wherein the solution annealing is carried out over a course of 5 minutes to 120 minutes.

17. The process as claimed in claim 11, wherein the heat treatment and the coating take place at a temperature of 150° C. to 300° C.

18. The process as claimed in claim 17, wherein the heat treatment and the coating are carried out over a course of 5 minutes to 240 minutes.

19. The process as claimed in claim 17, wherein the heat treatment and the coating are carried out over a course of 30 minutes to 60 minutes.

20. The process as claimed in claim 11, wherein the coating is carried out as one of cathodic or anionic dip-coating.

21. The process as claimed in claim 14, wherein the solution anneal temperature is about 490° C., for a time of about 30 minutes and the heat treatment and coating is carried out at a temperature of about 220° C. for about 45 minutes.

22. An aluminum component produced by the process of claim 11.
